(19) United States
(12) Patent Application Publication
(10) Pub. No.: US 2007/0124681 A1
(43) Pub. Date: May 31, 2007

(54) Presentation timer

(75) Inventors: Mohamed A. Abbar, Paris (FR); Ziad Khalidi, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/287,981

(22) Filed: Nov. 28, 2005

(51) Int. Cl. G06F 9/00

(52) U.S. Cl. 715/730

(57) ABSTRACT

A presentation timer provides a graphical representation of the presentation time during a presentation. The graphical representation of the presentation time is displayed in such a manner that it easily visible to the presenter but is not distracting to the presenter or the audience. An alert may also be configured such that the presenter is reminded of the time remaining within the presentation. The display and configuration of the presentation timer may be configured through a user interface. For example, a user may set the time allocated for the presentation, the alert time; the color, type, and location of the display as well as the parameters alert.

### BACKGROUND

Many individuals and businesses prepare and deliver presentations using a computer presentation program. Typically, presentation programs provide a user with a graphical user interface that allows the user to edit, create, and present slides. The slides include items such as text, lists, pictures, tables, charts, and the like. Many times when delivering a presentation, the presenter will have a time constraint. For example, the presenter may only have thirty minutes to deliver a presentation. In order to complete the presentation in the allotted time, the presenter must keep track of an external clock which can be very distracting. Additionally, during the presentation, the presenter may be stopped and asked questions that further make it difficult to present the slides within the allotted time. This delay may require the user to either skip some of the slides or not have enough time to finish the presentation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A presentation timer provides a graphical representation of the presentation time during a presentation. The graphical representation of the presentation time is displayed in such a manner that it easily visible to the presenter but is not distracting to the presenter or the audience. An alert may also be configured such that the presenter is reminded of the time remaining within the presentation. The display and configuration of the presentation timer may be configured through a user interface. For example, a user may set the time allocated for the presentation, the alert time; the color, type, and location of the display as well as the parameters alert.

### BRIEF DESCRIPTION OF THE DRAWINGS

FIG. 1 illustrates an exemplary computing device;

FIG. 2 shows a presentation timer system;

FIG. 3 shows a user interface for accessing timer options;

FIG. 4 illustrates a window for configuring presentation timer option; and

FIG. 5 shows an illustrative process for providing a presentation timer and optional alert, in accordance with aspects of the present invention.

### DETAILED DESCRIPTION

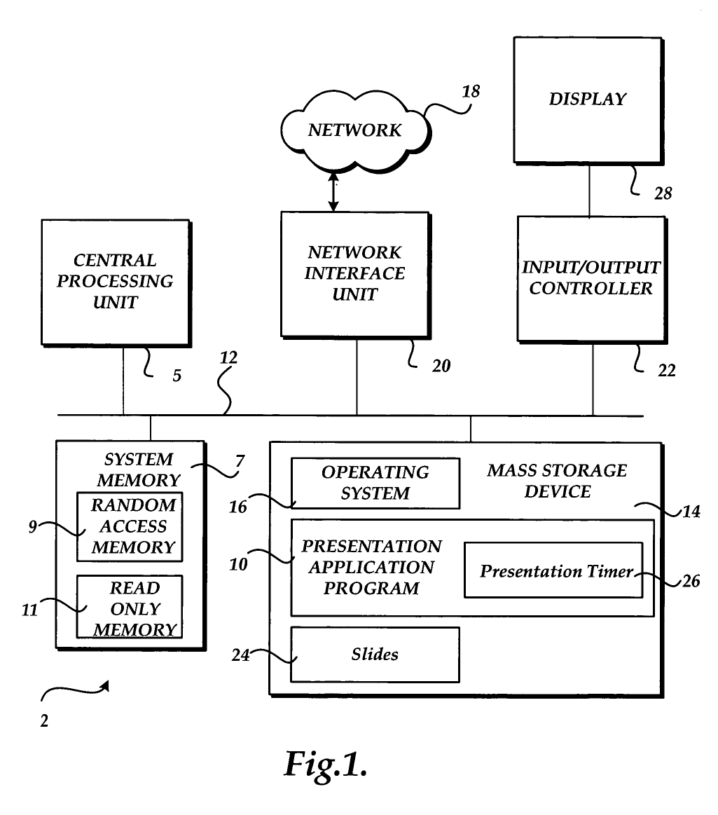

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 2 utilized in various embodiments will be described. The computer architecture shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 may also include an input/output controller 22 for receiving and processing input from a number of other devices, including a keyboard, mouse, a touch screen, a trackball, electronic stylus, and the like (not shown in FIG. 1). Similarly, an input/output controller 22 may provide output to a display screen 28, a printer, or other type of output device.

As mentioned briefly above, a number of program modules and data files may be stored in the mass storage device 14 and RAM 9 of the computer 2, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store a presentation application program 10 that is configured to be used within presentations. According to one embodiment, the presentation application 10 is the POWERPOINT application from MICROSOFT CORPORATION of Redmond, Wash. Other application programs may also be used. Generally, any presentation program may be used. Presentation program 10 may utilize slides 24 within the presentation. For example, presentation program 10 may be configured to present a slide show that includes one or more of slides 24.

Presentation Timer 26 is configured to assist a presenter in managing the timing of their presentations. As will be described in greater detail below, presentation timer 26 provides a graphical representation of the presentation time as well as an alert if configured.

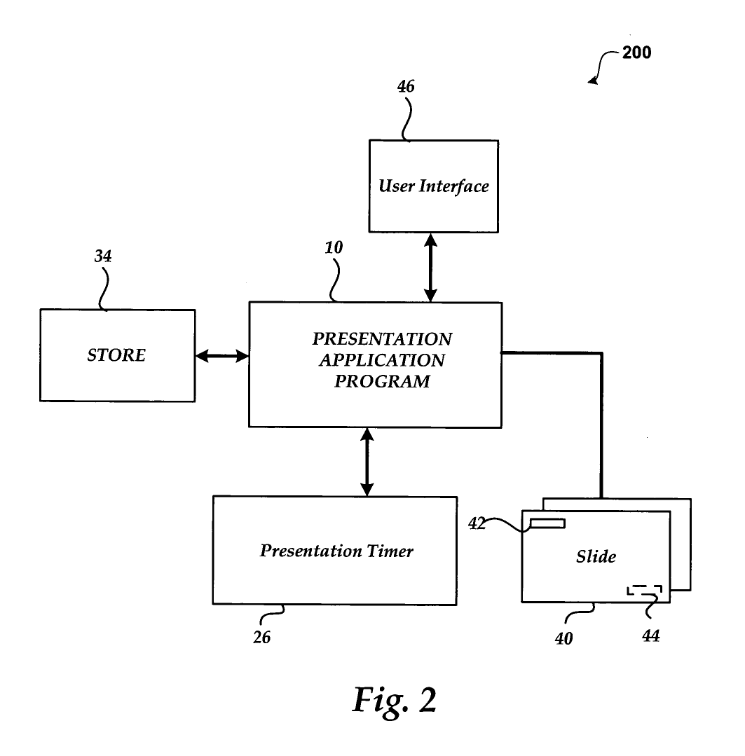

FIG. 2 shows a presentation timer system 200, in accordance with aspects of the invention. FIG. 2 provides additional details regarding the display and configuration of the presentation timer. As illustrated, system 200 includes presentation program 10, presentation timer 26, user interface 46, store 34, and slide 40. Slide 40 includes a location to display the presentation time 42 and an alert 44.

As described briefly above, the presentation timer 26 provides a graphical representation of the presentation time for a presentation 42 as well as an optional alert 44. According to one embodiment, the presentation time is the time that is remaining within a presentation. Alternatively, or in addition, the presentation time, may be the time elapsed during the presentation. The graphical representation of the presentation time is displayed in such a manner that it easily visible to the presenter but is not distracting to the presenter or the audience. According to one embodiment, the presentation time is displayed near a corner of slide 40 that is currently being displayed within the presentation. For example, the time remaining may be shown in the upper left, upper right, lower left, or lower right corner of slide 40. According to another embodiment, the presentation time may be shown on a secondary display that is coupled to the first display. Alert 44 may be shown near the display of the presentation time 42 or may be shown in an alternate location, such as at an opposite corner of the display or slide. Alert 44 may be configured such that the presenter is alerted at a specified time.

The display and configuration of the presentation timer may be configured through a user interface, such as user interface 46. User interface 46 may be configured to turn on and off the presentation timer as well as set the time allocated for the presentation, the alert time; the color of the time remaining display and alert display, the type of indicator used for the time remaining and alert as well as to specify the location of the time remaining and alert information. According to one embodiment, presentation time indicator 42 may be configured as a bar graph of the time remaining or as a countdown timer. Although not shown, the presentation time indicator 42 may be configured to show the time in other ways. For example, a clock, an hourglass, or some other indicator may be used. Similarly, alert 44 may be configured to blink and change colors based on the presentation time for the presentation.

Presentation application 10 is coupled to store 34 and may retrieve and store information relating to a presentation. According to one embodiment, store 34 is configured to store the slides that are associated with one or more presentations. Store 34 may also be utilized to store user preferences associated with the presentation. During a presentation, presentation program 10 interacts with presentation timer 26 to receive the timing information to be included within presentation time indicator 42 and alert indicator 44.

Presentation timer 26 provides presentation program 10 with the timing information such that slide 40 may be rendered to include the presentation time indicator 42. For example, presentation timer may provide the timing information every second during a presentation. In this way, the time remaining indicator may be updated each second.

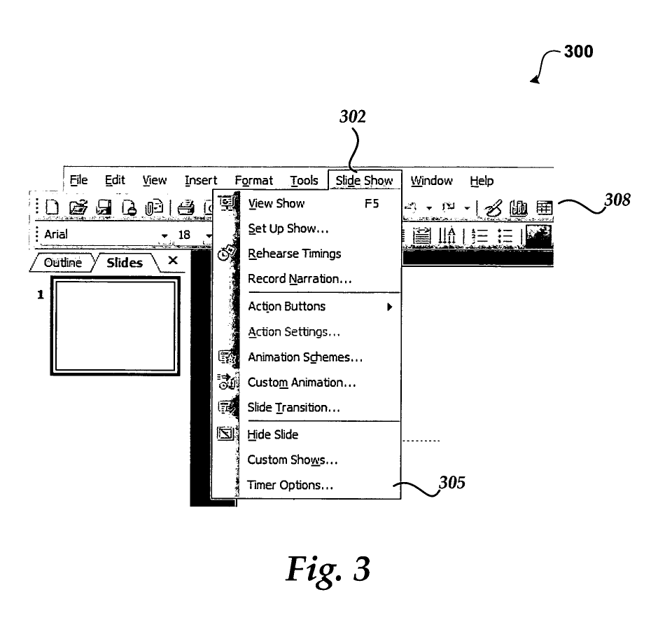

FIG. 3 shows a user interface for accessing timer options. As illustrated, interface 300 includes drop down menu 302 which includes timer options 305. Menu 302 is used to access the timer options 305 such that the presentation timer parameters may be configured for a presentation. Other types of user interface elements may be used to configure the timer options. For example, an icon may be included within toolbar 308. When timer option 305 is selected, a user interface window to adjust the timer options is presented to the user.

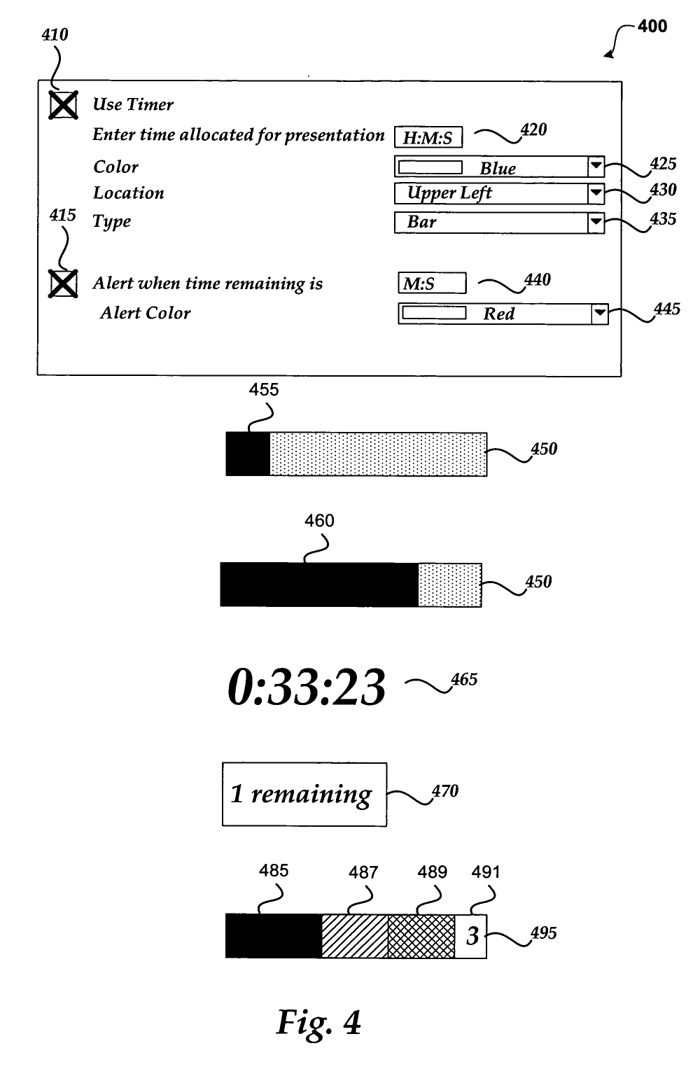

FIG. 4 illustrates a window for configuring presentation timer options. Window 400 includes user interface elements for configuring the options for the presentation timer. As illustrated, window 400 includes timer checkbox 410, alert checkbox 415, time input box 420, color menu 425, location menu 430, type menu 435, alert time input box 440 and alert color menu 445.

Time checkbox 410 is selected when a user desires to utilize the presentation timer during a presentation. When time checkbox 410 is selected, a user may enter the other parameters that are associated with the timer. The user has the ability to customize the “Timer Presentation” color and location of the “Timer” to avoid any layout/design conflict with the presentation.

Time input box 420 allows a user to enter the time that is allocated for the presentation. According to one embodiment, the time is input in the format: hours:minutes:seconds. Other methods may be used to enter the time. For example, a user may enter the number of minutes for the entire presentation; the number of thirty minute increments for a part of the presentation; and the like. Color menu 425 is used to select the color of the presentation time indicator. Any number of colors may be included within menu 425. The color selected is used as the primary color of the presentation time indicator. The selection of the color allows the presentation time to be distinguished from a slide background.

Location menu 430 is used to select the location of the presentation time indicator. As discussed above, according to one embodiment, the location may be any of the comers of the display slide. Alternatively, a user could enter the specific location of the presentation time indicator. For example, the user could enter the screen coordinates that they would like the time remaining display rendered. Type menu 435 allows the user to select the type of presentation time indicator that they would like to display. According to one embodiment, the user may select from a bar indicator 450 or a time display 465. As shown, time bar 450 is shown in two different time states as indicated by time elapsed 455 and time elapsed 460. As the time elapses within the presentation the fill is expanded to fill bar 450.

The user can also choose to set one or more alerts to notify the presenter of the available remaining time for the presentation. For example, a user may set a half-time alert and an alert when five minutes remain within the presentation. Alert check box 415 allows a user to specify the display of an alert at a predetermined time. Alert time input box 440 is used to enter the time when the alert is to be displayed. Alert color menu 445 is used to customize the color of the alert to avoid any color conflict with the presentation. Other options may also be included within window 400. For example, an alert location menu may be included to determine the location of the alert display. According to one embodiment, the alert display is shown in the lower right comer of the slide and provides a representation of the number of slides remaining (470).

Time bar 495 illustrates an exemplary presentation timer that is updated throughout the presentation such that the user can easily determine whether they are running on time within the presentation or whether they are behind in the presentation. According to one embodiment, a timer is configured to divide the time remaining within the presentation by the number of slides that remain to be shown in the presentation. For example, if there is fifteen minutes left and there are five slides that are left in the presentation, then the calculation would result in three minutes per slide. According to one embodiment, the color of the time bar 495 changes based on the time per slide remaining. For example, when the presentation is proceeding as expected, then time bar may be displayed green (illustrated by area 485). When the presentation is proceeding more slowly then expected but there is still time to catch up, the time bar is yellow indicating a caution state (indicated by area 487). When the time is at a critical point then time bar 495 is displayed as red (indicated by area 489) to provide a warning to the presenter. According to one embodiment, the number of slides remaining (491) may also be shown within time bar 495. The time per slide settings may be set by a user and/or they may be configured. For example, the user may desire five minutes per slide, be cautioned when there is only four minutes per slide and be warned when there is less than three minutes per slide. These settings may be changed based on the presentation. Other alerts may also be provided.

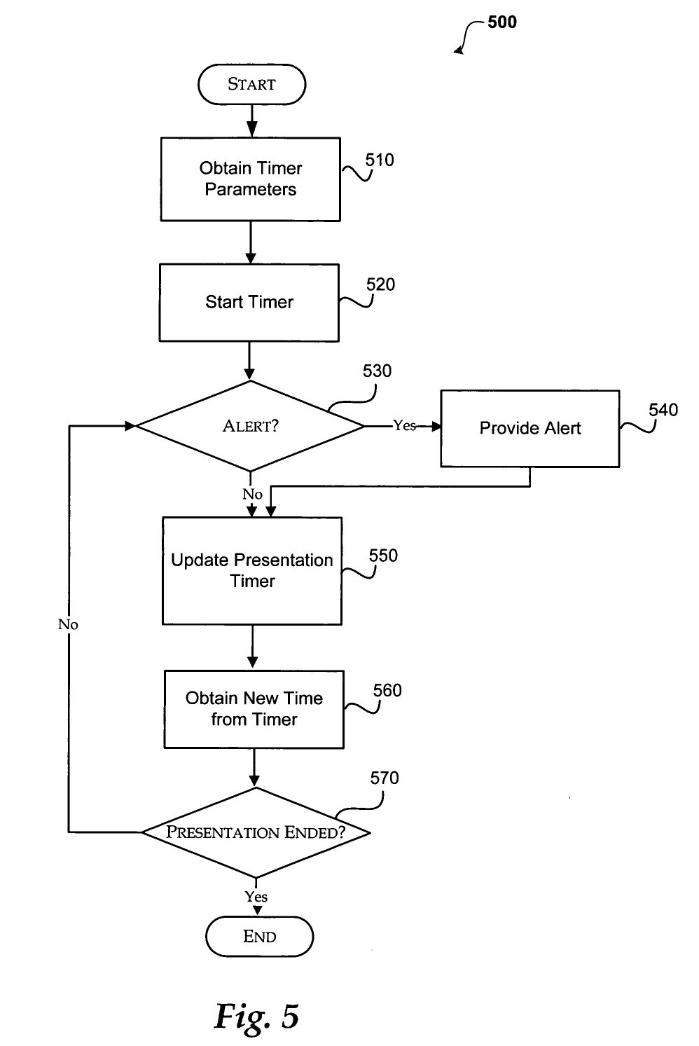

Referring now to FIG. 5, an illustrative process for providing a presentation timer and optional alert is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

Referring to FIG. 5, after a start operation, the process flows to operation 510, where the parameters for the presentation timer are obtained. As discussed above, the parameters relate to the time, location, and display of the presentation timer and optional alert.

Moving to operation 520, a timer is started. The timer is configured to run for at least as long as the allocated presentation time. For example, a presentation may have an allocated time of one hour and thirty minutes. In this case, the timer is set for ninety minutes. The same timer, or a separate timer, may be set for the alert.

Flowing to decision operation 530, a determination is made as to whether an alert is to be presented. The determination is based on whether an alert has been configured for the presentation as well as the time remaining within the presentation. When the time remaining within the presentation matches the desired alert time, or there is less time remaining then the desired alert time, the process flows to operation 540 where an alert is displayed. According to one embodiment, the alert is displayed in a location that is different than the location of the presentation timer. According to another embodiment, the alert may be displayed in conjunction with the presentation timer. For example, when the alert is to be presented, the presentation timer could change colors based on the alert. Any indication may be used so long as the presenter is made aware of the fact that the alert time has been reached and/or exceeded.

Transitioning to operation 550, the display of the presentation timer is updated with the current time of the presentation. According to one embodiment, the presentation timer display shows the time remaining within the presentation. According to another embodiment, the presentation timer display may show the time that has elapsed within the presentation.

At operation 560 the new presentation time is obtained from the timer. According to one embodiment, the new time is obtained each second during the presentation. As such, the presentation time indicator shows each second elapsed during the presentation. Other time periods may also be used. For example, each minute, five minutes and the like may be used. Additionally, the length of the presentation may be used in determining the granularity of the timer. For example, the longer the allocated presentation time the larger the granularity of the timer.

Moving to decision operation 570, a determination is made as to whether the presentation has ended. The presentation end is determined based on a comparison between the allocated presentation time and the time elapsed of the presentation. When the presentation has remaining time, the process returns to operation 530. When the presentation time has elapsed, the process flows to an end operation where the process returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for presenting a time with a presentation, comprising:
determining an allocated time for a presentation;
determining a presentation time relating to the allocated time during the presentation; and
displaying the presentation time on a display that is used when presenting the presentation.

2. The computer-implemented method of claim 1, further comprising determining when to provide an alert during the presentation.

3. The computer-implemented method of claim 2, wherein displaying the presentation time on the display comprises displaying the presentation time on a slide of the presentation that is currently being displayed.

4. The computer-implemented method of claim 3, wherein determining the presentation time during the presentation comprises determining a time remaining for the presentation.

5. The computer-implemented method of claim 3, wherein displaying the presentation time on the slide, comprises displaying the presentation time at one or more of the following locations: an upper left area of the slide; an upper right area of the slide; a lower right area of the slide and a lower left area of the slide.

6. The computer-implemented method of claim 3, wherein displaying the presentation time comprises displaying the presentation time as one of: a bar graph and a time display.

7. The computer-implemented method of claim 3, wherein providing the alert comprises displaying the alert during the presentation after an alert time.

8. The computer-implemented method of claim 1, further comprising setting: a color of the display of the presentation time; a location of the display of the presentation time; and a type of time display for the presentation time.

9. A computer-readable medium having computer-executable instructions for presenting a remaining time during a presentation, comprising:
determining the remaining time during the presentation;
determining a location to display the remaining time; and
displaying the remaining time on a slide of the presentation while the slide is being presented.

10. The computer-readable medium of claim 9, wherein displaying the remaining time on the slide, comprises displaying the presentation time at one of the following locations: an upper left area of the slide; an upper right area of the slide; a lower right area of the slide and a lower left area of the slide.

11. The computer-readable medium of claim 10, further comprising displaying an alert during the presentation that provides another indication during the presentation.

12. The computer-readable medium of claim 11, wherein displaying the remaining time comprises displaying a bar graph that provides a graphical representation of the remaining time.

13. The computer-readable medium of claim 11, wherein displaying the remaining time comprises displaying a textual display of the remaining time.

14. The computer-readable medium of claim 11, wherein displaying the alert comprises displaying a number of slides remaining within the presentation.

15. The computer-readable medium of claim 11, further comprising obtaining a color; a location; and a type that relates to the display of the remaining time and the alert.

16. A system for displaying a presentation time, comprising:
a presentation application that is configured to:
set an allocated time for a presentation;
display slides that are associated with the presentation; and
display a presentation time on a display that is used when presenting the slides of the presentation; and
a timer that is coupled to the presentation application and that is configured to generate the presentation time during the presentation.

17. The system of claim 16, wherein the presentation application is further configured to display an alert during the presentation.

18. The system of claim 16, wherein displaying the presentation time on the display comprises displaying the presentation time on a slide of the presentation.

19. The system of claim 18, wherein displaying the presentation time on the slide, comprises displaying the presentation time at one of the following locations: an upper left area of the slide; an upper right area of the slide; a lower right area of the slide and a lower left area of the slide.

20. The system of claim 19, further comprising obtaining a color of the display of the presentation time; a location of the display of the presentation time; and a type of time display for the presentation time.
